(19) United States
(12) Patent Application Publication
(10) Pub. No.: US 2024/0188702 A1
(43) Pub. Date: Jun. 13, 2024

(54) STACKABLE ATTACHMENT COMBS FOR ELECTRIC HAIR TRIMMER

(71) Applicant: SPECTRUM BRANDS, INC., Middleton, WI (US)

(72) Inventors: Thomas Manders Franklin, Middleton, WI (US); David R. Hillenbrand, Middleton, WI (US); David Yet Toy, Middleton, WI (US); Michael John deGrood, Middleton, WI (US); Alan T. McDonald, Middleton, WI (US); Mark Miller, Middleton, WI (US); Karen Shrider Baer, Middleton, WI (US)

(21) Appl. No.: 18/554,575

(22) PCT Filed: Apr. 28, 2022
(86) PCT No.: PCT/US2022/026670

§ 371 Date: Oct. 9, 2023

Related U.S. Application Data
(60) Provisional application No. 63/181,952, filed on Apr. 29, 2021.

(51) Int. Cl. A45D 24/36; B26B 19/20

(52) U.S. Cl. CPC A45D 24/36; B26B 19/20

(57) ABSTRACT

A stackable attachment comb for an electric hair trimmer includes a body configured to releasably attach to the electric hair trimmer and teeth projecting from the body. The teeth are arranged to direct hair toward a blade assembly for cutting during operation of the electric hair trimmer if the body is attached to the blade assembly. The stackable attachment comb includes an engagement feature configured to attach the stackable attachment comb to another comb.

This application claims priority to U.S. Provisional application Ser. No. 63/181,952, filed Apr. 29, 2021, which is incorporated herein by reference in its entirety.

### BACKGROUND

The present disclosure relates generally to attachments for grooming appliances and, more particularly, to stackable attachment combs for electric hair trimmers.

Conventional electric hair trimmers include a blade assembly for cutting human or animal hair. The electric hair trimmers may include removable attachment combs that allow the user to cut the hair to different lengths. Typically, to switch cut lengths the user of the electric hair trimmer must remove an attachment comb from the blade assembly and replace it with a different attachment comb. A different attachment comb is attached to the hair trimmer for each cut length. In addition, different attachments may be used to provide different styles of hair and/or for cutting hair in different areas of the body. The multiple attachments may be loosely stored in a container such as box or drawer. Alternatively, the user may store attachments on a counter or surface. However, the attachments may be difficult to retrieve from the containers or the surface because the attachments are not organized within the containers or on the surface. For example, it may be difficult for a user to quickly identify a desired attachment among the loose attachments. In addition, the attachments are easily misplaced and increase the clutter in a workspace.

Thus, there is a need for a system for organizing and storing attachments for an electric hair trimmer in an easily accessible and compact manner.

### BRIEF DESCRIPTION

In one embodiment, a stackable attachment comb for an electric hair trimmer includes a body configured to releasably attach to the electric hair trimmer and teeth projecting from the body. The teeth are arranged to direct hair toward a blade assembly of the electric hair trimmer for cutting during operation of the electric hair trimmer if the body is attached to the electric hair trimmer. The stackable attachment comb includes an engagement feature integrally formed with the body and configured to attach the stackable attachment comb to another comb.

In another embodiment, an attachment set for use with a hair trimmer includes a first comb including teeth, and a second comb including teeth. The first comb includes an engagement feature configured to attach the first comb to the second comb and to the hair trimmer.

In another embodiment, an electric hair trimmer kit includes an electric hair trimmer having a blade assembly. The blade assembly is operable to cut hair during operation of the electric hair trimmer. The electric hair trimmer kit also includes a plurality of combs configured to releasably attach to the electric hair trimmer and direct hair toward a blade assembly for cutting during operation of the electric hair trimmer. Each comb includes teeth. At least one of the combs includes an engagement feature configured to attach the combs together in a stacked arrangement if the combs are detached from the electric hair trimmer.

In another embodiment, a set of stackable attachment combs for use with a hair trimmer is provided. Each stackable attachment comb of the set includes teeth. At least one stackable attachment comb of the set includes an engagement feature configured to attach the stackable attachment comb to another stackable attachment comb of the set and to the hair trimmer.

### BRIEF DESCRIPTION OF THE DRAWINGS

FIG. 1 is a top view of an electric hair trimmer having a blade assembly, one suitable embodiment of a stackable comb of the present disclosure being attached to the blade assembly of the trimmer;

FIG. 2 is a schematic view of a portion of the trimmer of FIG. 1 illustrating operation of the trimmer to cut hair;

FIG. 3 is a perspective view of a set of stackable combs for use with the trimmer of FIG. 1, the stackable combs being shown attached to each other in a stacked arrangement;

FIG. 4 is a side view of the stackable combs of FIG. 3 in the stacked arrangement;

FIG. 5 is a sectional view of the stackable combs of FIG. 3, taken along line B-B.

FIG. 6 is a perspective of the stackable combs of FIG. 3, the combs being shown detached from each other;

FIG. 7 is a side view of the stackable combs of FIG. 3, the combs being shown detached from each other;

FIG. 8 is a perspective view of a first stackable comb of the set shown in FIG. 3;

FIG. 9 is a top view of the first stackable comb of FIG. 8;

FIG. 10 is a rear view of the first stackable comb of FIG. 8;

FIG. 11 is a front view of the first stackable comb of FIG. 8;

FIG. 12 is a side view of the first stackable comb of FIG. 8;

FIG. 13 is another perspective view of the first stackable comb of FIG. 8 illustrating a blade facing surface of the comb;

FIG. 14 is a first perspective view of a second stackable comb of the set shown in FIG. 3;

FIG. 15 is a second perspective view of the second stackable comb of FIG. 14 illustrating a blade facing surface of the comb;

FIG. 16 is a first perspective view of a third stackable comb of the set shown in FIG. 3;

FIG. 17 is a second perspective view of the third stackable comb of FIG. 16 illustrating a blade facing surface of the comb;

FIG. 18 is a first perspective view of a fourth stackable comb of the set shown in FIG. 3;

FIG. 19 is a second perspective view of the fourth stackable comb of FIG. 18 illustrating a blade facing surface of the comb;

FIG. 20 is a first perspective view of a fifth stackable comb of the set shown in FIG. 3; and

FIG. 21 is a second perspective view of the fifth stackable comb of FIG. 20 illustrating a blade facing surface of the comb.

Corresponding reference characters indicate corresponding parts throughout the several views of the drawings.

### DETAILED DESCRIPTION

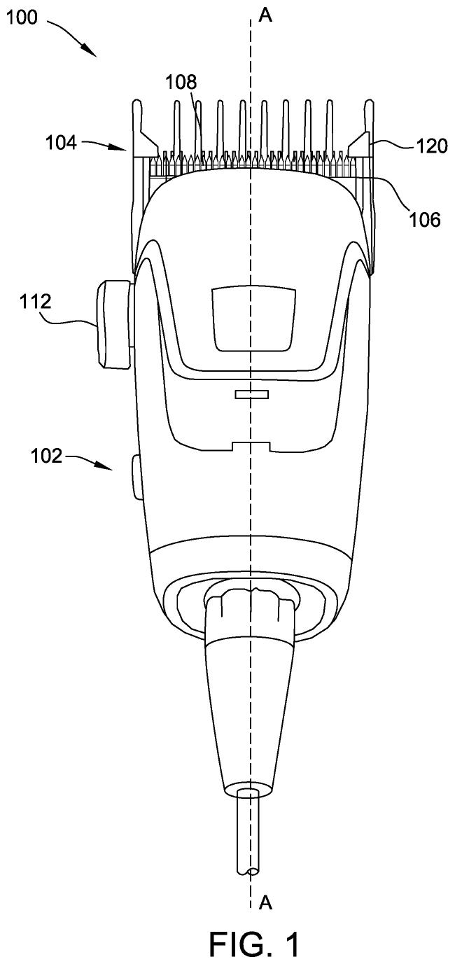

Referring now to the drawings, and in particular to FIGS. 1-3, a conventional electric hair trimmer (broadly, a grooming appliance) is indicated generally by 100. As illustrated in FIG. 1, the trimmer 100 defines a longitudinal axis A-A. The illustrated trimmer 100 comprises a handle (indicated generally by 102) defining an internal chamber (not shown), and a head (indicated generally by 104) located at a distal end of the handle. In the illustrated embodiment, the head 104 is selectively detachable from and reattachable to the handle 102. In other embodiments, however, the head 104 may not be detachable from the handle 102.

The head 104 of the trimmer 100 includes a blade assembly 106 having a plurality of blades 108. The blades 108 define a blade edge 110. The head 104, including the blade assembly 106, is removably coupled to the handle 102. In the illustrated embodiment, the handle 102 includes a release mechanism, such as a release lever 112. Actuation of the release lever 112 facilitates removal of the blade assembly 106 from the handle 102. During operation of the trimmer 100, an electric motor (not shown) located within the internal chamber of the handle 102 causes at least one blade of the plurality of blades 108 to oscillate side to side via a drive mechanism.

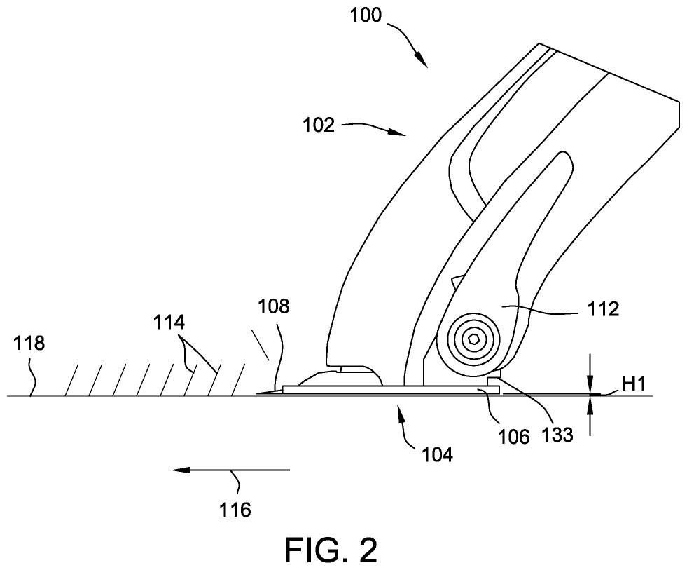

With reference to FIG. 2, the relative oscillation of the plurality of blades 108 cuts hair 114 as the trimmer 100 is moved in a cutting direction 116. As seen in FIG. 2, the trimmer 100 can be used to cut hair to a height H1. In the illustrated example, the height H1 is approximately equal to the distance between the plurality of blades 108 and a person's skin 118 when the trimmer 100 is moved along the person's skin 118 to cut the hair 114.

Referring to FIGS. 1 and 2, a stackable attachment comb 120 is releasably attachable to the head 104 of the trimmer 100. During operation of the trimmer 100, the stackable attachment comb 120 causes the plurality of blades 108 of the trimmer 100 to cut the hair 114 at a height greater than a cutting height H1 of the plurality of blades 108 without the stackable attachment comb 120 attached thereto. The stackable attachment comb 120 is selectively removeably engaged with the head 104. Thus, the stackable attachment comb 120 can be manually attached to and detached from the head 104 of the trimmer 100 by the user.

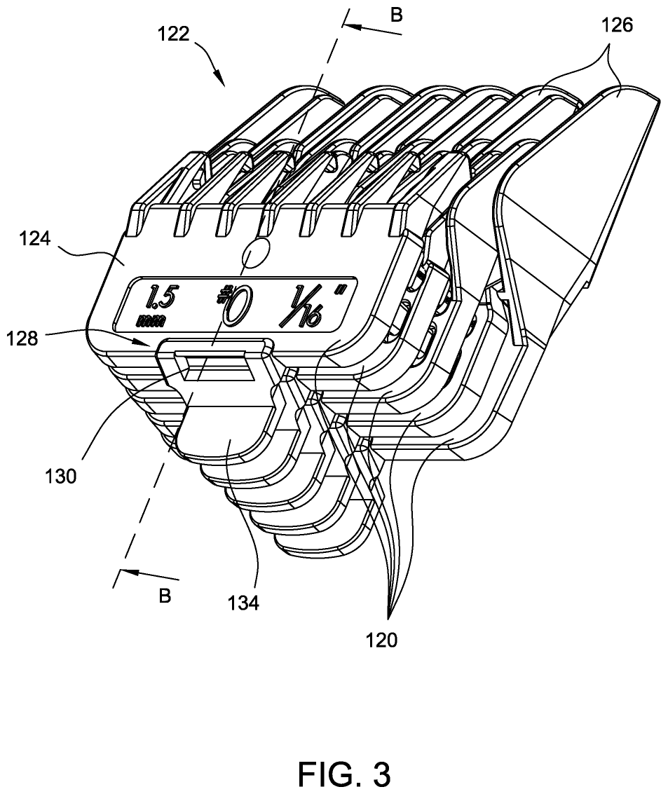

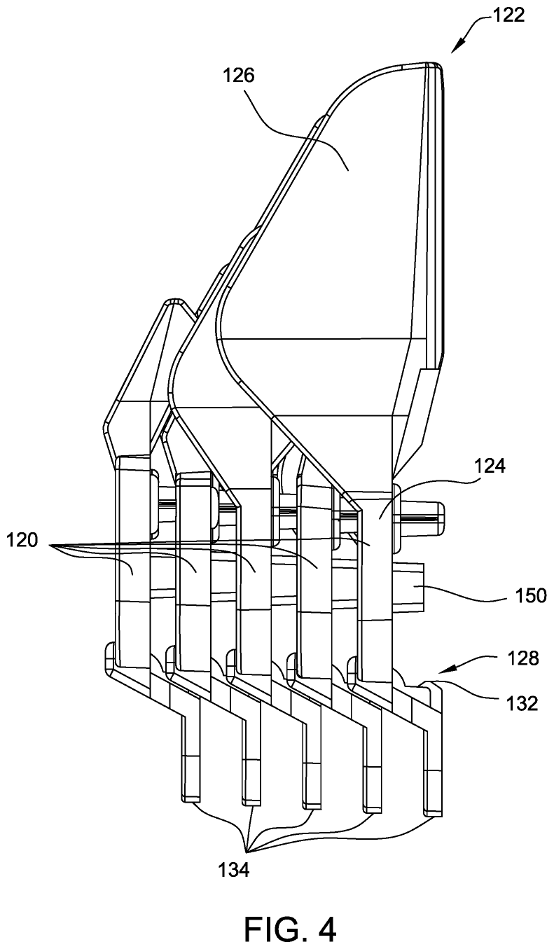

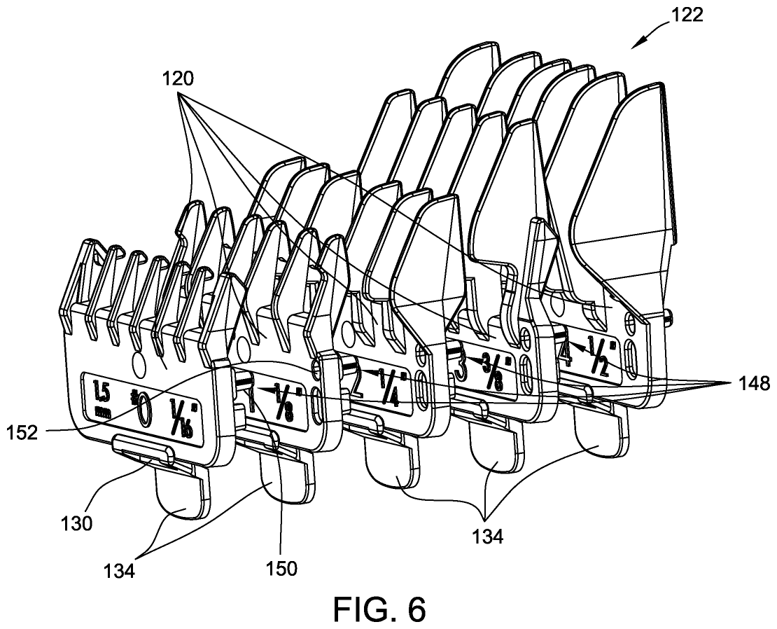

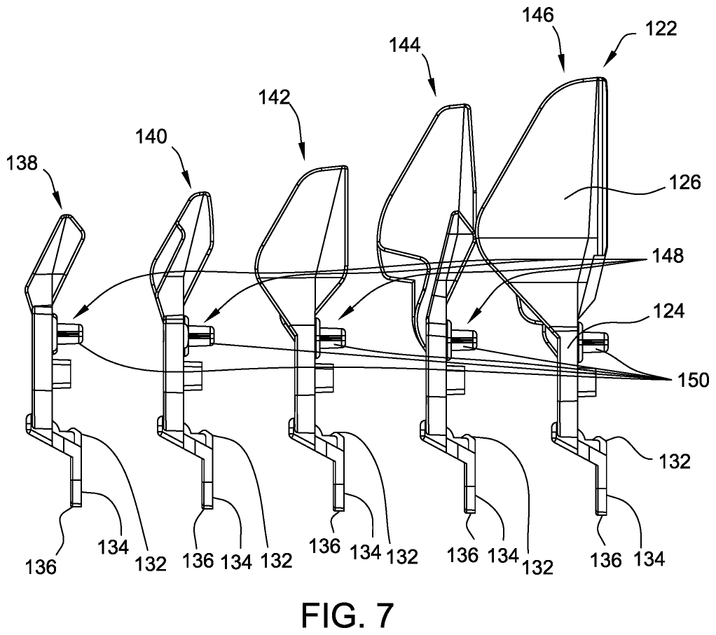

FIGS. 3-7 illustrate one suitable embodiment of a set, indicated generally at 122, of stackable combs 120. Each stackable attachment comb 120 of the set 122 is configured to removably attach to the blade assembly 106 of the trimmer 100 (shown in FIG. 1) to cut the hair 114 at a height greater than a cutting height H1 of the plurality of blades 108 without the stackable attachment comb 120 attached thereto. For example, each comb 120 of the set 122 includes a body 124 configured to releasably attach to the blade assembly 106 (shown in FIG. 1) of the electric hair trimmer 100 (shown in FIG. 1) and teeth 126 projecting from the body 124. The teeth 126 are configured to direct hair toward the blade assembly 106 for cutting during operation of the electric hair trimmer 100. In the example, the stackable combs 120 are sized to provide hair cut lengths of 1.5 millimeters (mm), 3 mm, 6 mm, 9 mm, and 12 mm. In other embodiments, the set may include stackable combs 120 of other sizes.

Each comb 120 includes at least one engagement feature 128 integrally formed with the body 124 and configured to attach the comb to another comb as shown in FIGS. 3-5. For example, the engagement features 128 comprise a slot 130 defined in the body 124 and a latch 132. The latch 132 extends from the body 124 and is configured to engage the slot 130 in the body 124 of another comb 120. In addition, the latch 132 is configured to extend into and engage a cavity 133 (shown in FIG. 2) adjacent the blade assembly 106 of the trimmer 100 to secure the comb 120 onto the head 104 of the trimmer 100. In other embodiments, the combs 120 may include other engagement features 128 such as clips, projections, openings, and magnets without departing from some aspects of the disclosure.

Each comb 120 includes a tab 134 that is sized and arranged for a user to contact and release the comb 120 from the blade assembly 106. For example, a distal end 136 of the tab 134 extends outward from the body 124 for a user to press. The latch 132 is connected to the tab 134 at a location spaced from the distal end 136 of the tab 134 such that the tab 134 provides a lever arm for operation of the latch 132. For example, when a user presses on the distal end 136, the tab 134 flexes outward from the body 124 and the latch 132 is disengaged from the blade assembly 106. The comb 120 may attach to the blade assembly 106 in other manners without departing from at least some aspects of the disclosure. For example, in some embodiments, the comb 120 or the blade assembly 106 may include one or more rails that extend into slots in the other of the comb 120 or the blade assembly 106 to secure the comb 120 onto the trimmer 100.

The engagement features 128 of each comb 120 are configured to engage the engagement features 128 of another comb 120 to attach the combs 120 together. For example, the latch 132 is configured to extend into the slot 130 of another comb 120. The latch 132 and the slot 130 of the combs 120 provide a snap fit engagement that is simple to attach and detach. For example, the combs 120 are aligned and pressed together to attach to each other. The user may press on the tab 134 to release one of the combs 120 from another comb 120. Accordingly, the combs 120 are simpler to manufacture and use because the combs 120 utilize the same tabs 134 to attach to and detach from the blade assembly 106 and other combs 120.

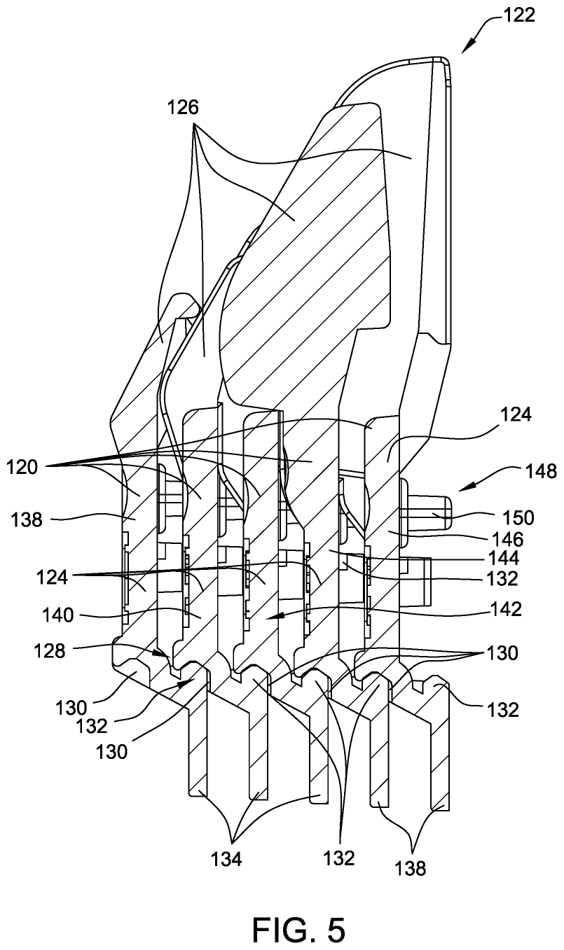

The stackable combs 120 are configured to attach together in a stacked configuration as shown in FIG. 5. In the example, the combs 120 are arranged in order of size such that the comb 120 providing the smallest cut is on one end of the stack, the comb 120 providing the largest cut is on the opposite end of the stack, and the combs 120 between the ends are arranged from smallest to largest. For example, the stackable combs 120 include, in order of smallest to largest, a first stackable comb 138, a second stackable comb 140, a third stackable comb 142, a fourth stackable comb 144, and a fifth stackable comb 146. In the example, the first stackable comb 138 is a 1.5 mm comb, the second stackable comb 140 is a 3 mm comb, the third stackable comb 142 is a 6 mm comb, the fourth stackable comb 144 is a 9 mm comb, and the fifth stackable comb 146 is a 12 mm comb. In other embodiments, the combs 120 may have different sizes and/or be arranged in a different order without departing from some aspects of the disclosure. In other embodiments, the set 122 may have more or fewer combs 120 without departing from some aspects of this disclosure.

Suitably, at least one of the combs 120 includes an alignment feature 148 (shown in FIGS. 5, 12, and 13) that is configured to align the combs 120 in the stacked arrangement. For example, the combs 120 in the middle of the stack (i.e., the second stackable comb 140, the third stackable comb 142, and the fourth stackable comb 144 in the illustrated embodiment) include alignment features 148 on front and back sides to engage and align with combs 120 on both sides of the comb 120. The combs 120 on the end of the stack (i.e., the first stackable comb 138 and the fifth stackable comb 146 in the illustrated embodiment) include alignment features 148 on at least a side of the comb 120 that faces the adjacent comb 120. In the illustrated embodiment, the alignment features 148 comprise posts 150 and openings 152. Each post 150 is configured to extend into an opening 152 defined by another comb 120.

In the stacked configuration, the bodies 124 of the combs 120 are aligned with each other and the teeth 126 of the combs 120 are parallel and extend alongside each other. The teeth 126 of adjacent combs 120 are offset such that the teeth 126 do not interfere with each other when the combs 120 are in the stacked arrangement. For example, each of the combs 120 has a spacing between the teeth 126 that is different from the spacing between the teeth 126 of another comb 120.

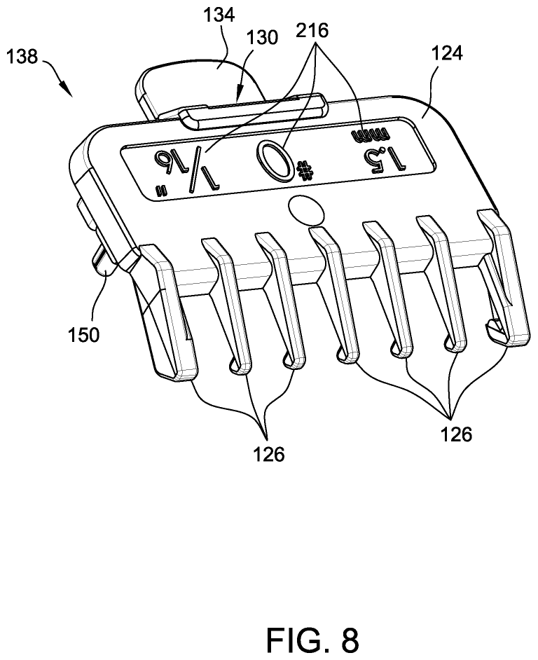

FIGS. 8-13 show the first stackable comb 138 of the set 122 (shown in FIG. 3). In the illustrated embodiment, the first stackable comb 138 is configured to provide a cut length of approximately 1.5 mm when used with the trimmer 100 (shown in FIG. 1). Accordingly, the first stackable comb 138 of the illustrated embodiment is the smallest comb 120 of the set 122. In some embodiments, the set 122 includes combs 120 that are smaller than the first stackable comb 138 seen in FIGS. 8-13.

The first stackable comb 138 includes a body 124 and teeth 126 extending outward from the body 124. The body 124 includes a back edge 154, a front edge 156, a first side edge 158, and a second side edge 160. The first side edge 158 and the second side edge 160 each extend from the back edge 154 to the front edge 156. The comb 120 also includes the skin-facing side 162 and an opposing blade-facing side 164. The blade-facing side 164 faces the blade assembly 106 when the comb 120 is attached to the trimmer 100 and includes an inner blade facing surface 166 defined between the back edge 154 and the two opposing side edges 158, 160. The skin-facing side 162 includes an outer surface 168.

The first stackable attachment comb 120 is configured to releasably attach to the blade assembly 106 of the electric hair trimmer 100 such that the inner surface 166 extends along the blade assembly 106 and the teeth 126 guide hair toward the blade assembly 106 during operation of the trimmer 100. The first stackable attachment comb 120 is configured to attach to another comb 120 such that the outer surface 168 faces the inner blade facing surface 166 of another comb 120. In the illustrated embodiment, the inner blade facing surface 166 and the outer surface 168 are planar. In alternative embodiments, the inner blade facing surface 166 and/or the outer surface 168 may be non-planar.

The teeth 126 of the stackable attachment comb 120 include a first outer tooth 170 extending at or adjacent the first side edge 158 of the first stackable comb 138, a second outer tooth 172 extending at or adjacent the second side edge 160, and intermediate teeth 174 arranged between the first outer tooth 170 and the second outer tooth 172. As illustrated in FIG. 8, the first stackable comb 138 includes five of the intermediate teeth 174. It will be appreciated, however, that the stackable comb 138 may include more or less teeth 126 without departing from some aspects of this disclosure.

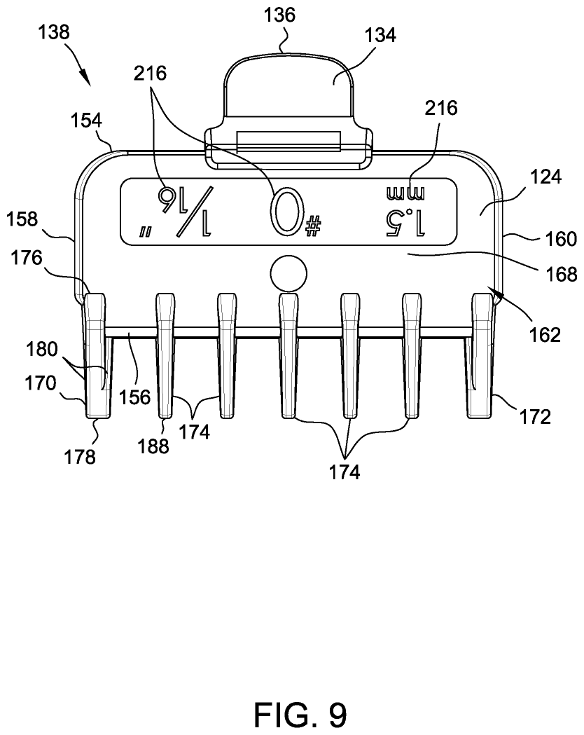

As best seen in FIG. 9-11, on the skin-facing side 162, each tooth 126 has a proximal end 176 extending outward and forward from the outer surface 168 of the skin-facing side 162, a distal end 178 at the front edge 156, and tooth sides 180 therebetween. Each tooth 126 also includes a transition portion 182 between the proximal end 176 and the distal end 178, an apex 184 within the transition portion 182, and a skin-contacting edge 186 between the transition portion 182 and the distal end 178. The apex 184 represents the outermost point of each tooth 126 relative to the outer surface 168. The skin-contacting edge 186 represents the portion of the comb 120 that contacts the person's skin during operation of the trimmer 100. Each tooth 126 has a curved or angled shape from the proximal end 176 to the distal end 178.

With reference to FIG. 12, each tooth 126 has a tip 188 at the distal end 178. Each tooth 126 has a length L as measured from the tip 188 to the proximal end 176. The tip 188 of each of the teeth 126 has a curved, or rounded, shape. In other suitable embodiments, the tip 188 may have any shape that allows the stackable attachment comb 120 to function as described herein, such as a triangular or rhombus shape. During operation of the trimmer 100, the tip 188 of each of the teeth 126 is the first point of contact with the hair 114 as the teeth 126 separate the hair 114 when the stackable attachment comb 120 traverses along or adjacent the person's skin 202 during the hair cutting operation.

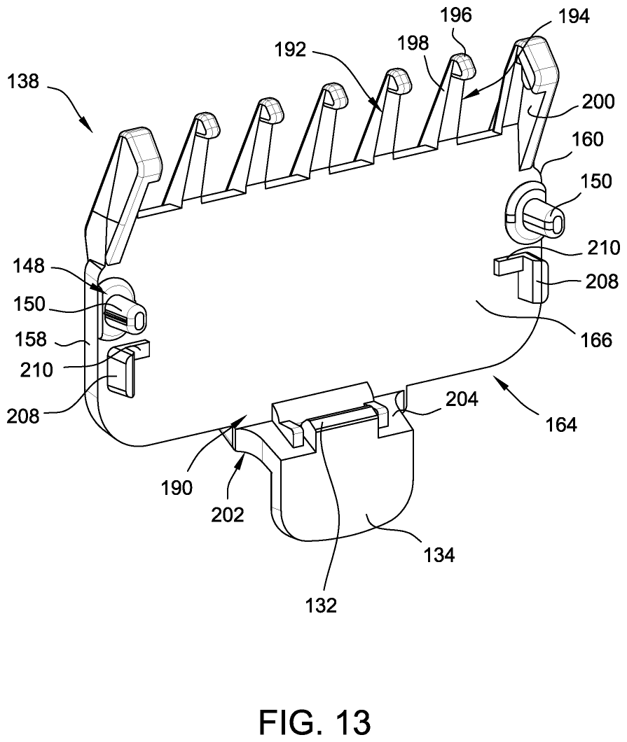

With reference now to FIG. 13, the blade-facing side 164 of the stackable attachment comb 120 includes a back blade engagement section 190 and a front blade engagement section 192. The front blade engagement section 192 is situated at the front edge 156 of the stackable attachment comb 120. The front blade engagement section 192 includes a slot 194 defined within each of the teeth 126. The slot 194 is configured to receive the plurality of blades 108. Each tooth 126 includes an overhang region 196 and a base region 198. The overhang region 196 and the base region 198 define the slot 194. The first outer tooth 170 and the second outer tooth 172 each include a front side guard 200 to prevent forward and side movement of the comb 120 when the blade assembly 106 is inserted into the slot 194.

The back blade engagement section 190 of the body 124 includes a rear guard 202 extending outward from the back edge 154 of the body 124 opposite the teeth 126. The rear guard 202 includes the latch 132 and the tab 134 on opposite sides of the rear guard 202. The rear guard 202 prevents rearward movement by the comb 120 when the blade assembly 106 is inserted into the slot 194. The rear guard 202 includes a leg 204. The leg 204 of the rear guard 202 extends at an angle relative to the inner and outer surfaces 166, 168 (i.e., the leg 204 is non-planar with the inner and outer surfaces 166, 168). In the example, the leg 204 extends at an oblique angle relative to the inner and outer surfaces 166, 168. The shape and arrangement of the rear guard 202 facilitates the snap fit connection of the first stackable comb 138 onto another comb 120 or the blade assembly 106 (shown in FIG. 1).

The tab 134 extends outward from the leg 204 and is parallel to the inner and outer surfaces 166, 168 of the body 124. The tab 134 is arranged for a user to contact a distal end of the tab 134 to detach the comb 138 from the trimmer 100 or another comb 120. The tab 134 and the rear guard 202 are at least partially flexible to allow the latch 132 to be disengaged from the slot 130 when the user contacts the tab 134.

The latch 132 extends from the rear guard 202 towards the front edge 156. Specifically, in the example, the latch 132 extends from an interior surface of the leg 204 and faces the blade assembly 106 or an adjacent comb 120 when the first stackable comb 138 is attached to the trimmer 100 or another comb 120. Also, the latch 132 is configured to engage a portion of the blade assembly 106 to lock the comb 120 to the blade assembly 106. In other suitable embodiments, the latch 132 may engage the handle 102 or another portion of the head 104 of the trimmer 100. The tab 134 extends rearwardly away from the latch 132 and is configured to assist the user in disengaging the latch 132 from its locked position, allowing removal of the comb from the trimmer 100.

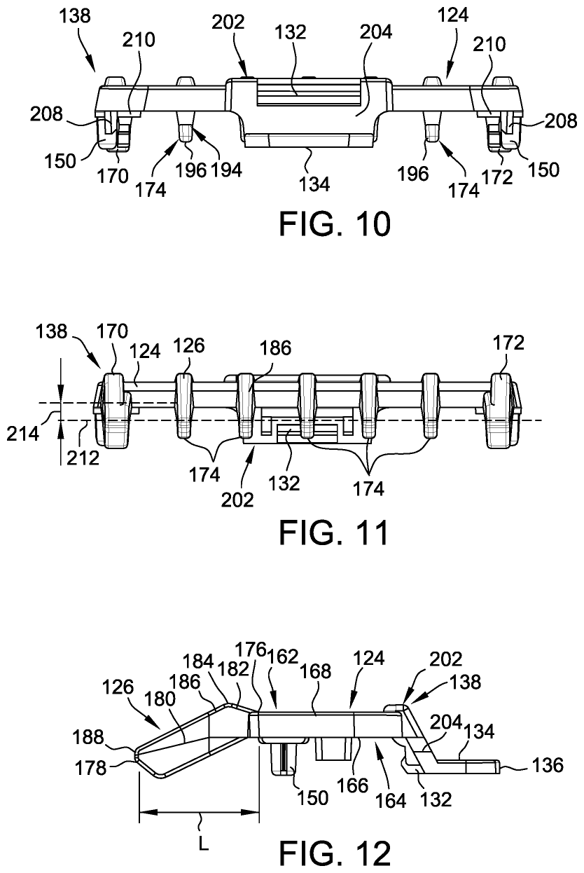

In the illustrated embodiment, the slot 130 is defined in the rear guard 202 of the body 124 and extends along at least a portion of the back edge 154. The slot 130 is positioned opposite the teeth 126 of the comb 138 and is arranged to receive the latch 132 of another comb 120. As shown in FIG. 10, the slot 130 extends along a majority (i.e., greater than 50%) of the width of the tab 134 and is aligned with the tab 134. The slot 130 has a depth that is greater than the height of the latch 132.

The inner blade facing surface 166 of the blade-facing side 164 includes side guards 208 and spacers 210. The side guards 208 are situated at or adjacent the first side edge 158 and the second side edge 160 to prevent side movement of the comb 120 when the blade assembly 106 is inserted into the slot 194. In the exemplary embodiment, a side guard 208 is located on each of the opposing side edges 158, 160. In other suitable embodiments, the comb 120 may have more, fewer, or no side guards 208. The spacers 210 abut the blade assembly 106 when the blade assembly 106 is inserted into the slot 194. The spacers 210 prevent contact of the entire blade-facing side 164 with the blade assembly 106. In the illustrated embodiment, the comb 120 has two spacers 210, but in alternative embodiments, the comb 120 has more, fewer, or no spacers 210.

With reference to FIG. 11, a cutting line 212 represents the positioning of the blades 108 when the blade assembly 106 is situated within the slot 194. Each of the intermediate teeth 174 space the blades 108 from the skin and provide a cutting height 214 when the trimmer 100 (shown in FIG. 1) is moved a long a skin surface and used to cut hairs protruding from the skin. The cutting height 214 is the shortest distance between the cutting line 212 and the outermost point of the skin-contacting edge 186 within the cutting plane.

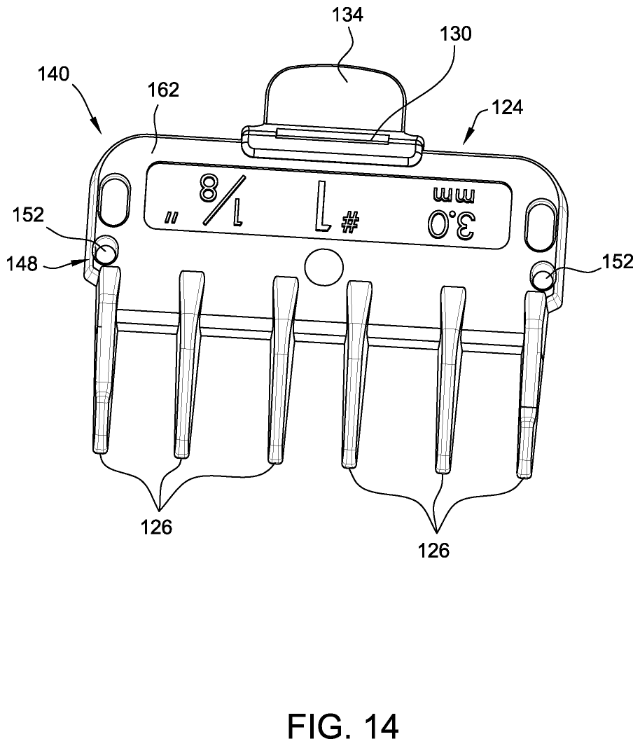

Referring to FIGS. 12 and 13, the first stackable comb 138 includes posts 150 extending from the inner surface 166. In the example, the posts 150 are cylinders and extend along a center axis perpendicular to the inner surface 166. The posts 150 are positioned on opposite sides of the first stackable comb 138 in proximity to the teeth 126. The posts 150 are sized to fit into openings 152 (shown in FIG. 14) in another comb 120 and align the first stackable comb 138 and the other comb 120. The posts 150 may abut a surface or edge of a blade of the blade assembly 106 and/or engage the blade assembly 106 when the first stackable comb 138 is attached to the blade assembly 106.

In the illustrated embodiment, the teeth 126, the body 124, the engagement features 128, the alignment features 150, 152, and the tab 134 are integrally formed as a single piece. Accordingly, the first stackable attachment comb 120 is less expensive to manufacture and is more durable than combs including multiple pieces. In addition, the first stackable attachment comb 120 may be simpler to attach to or detach from the trimmer 100 or other combs 120 because the first stackable comb 138 is a single piece and has a snap-fit connection. Moreover, the first stackable attachment comb 120 utilizes the same features to connect to the trimmer 100 and/or other combs 120.

In the illustrated embodiment, the first stackable comb 138 includes informational images 216. Each of the informational images 216 indicates the size of the first stackable comb 138. In the illustrated embodiment, for example, the informational images include “1.5 mm”, “#0”, and “ 1/16″”.

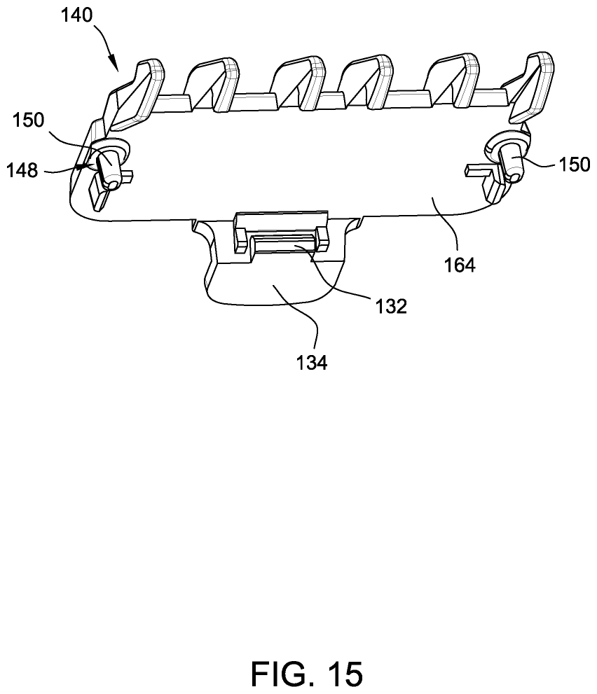

FIGS. 14 and 15 show a second stackable comb 140 of the set 122 (shown in FIG. 3). The second stackable comb 140 is similar to the first stackable comb 138 except the second stackable comb 140 is a different size than the first stackable comb 140. In the illustrated embodiment, the second stackable comb 140 is configured to provide a cut length of approximately 3 mm when used with the trimmer 100 (shown in FIG. 1).

In addition, the second stackable comb 140 includes openings 152 defined in the skin-facing side 162. The openings 152 are arranged to receive the posts 150 of another comb 120 of the set 122 that may be attached on the skin-facing side 162 of the second stackable comb 140.

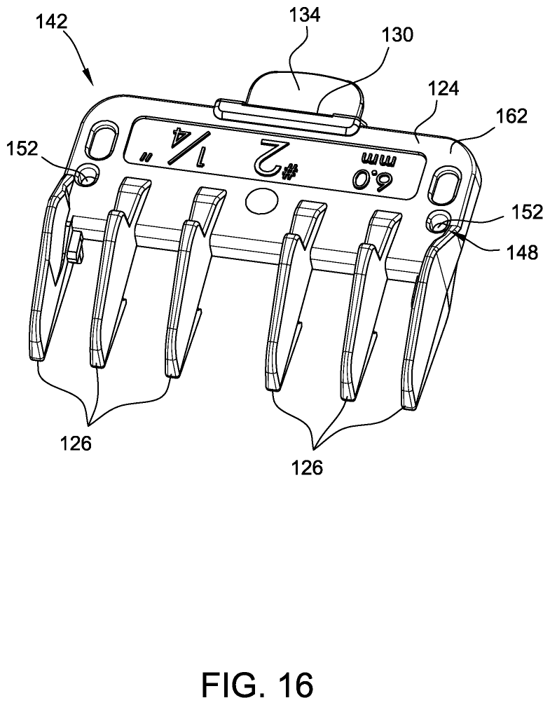

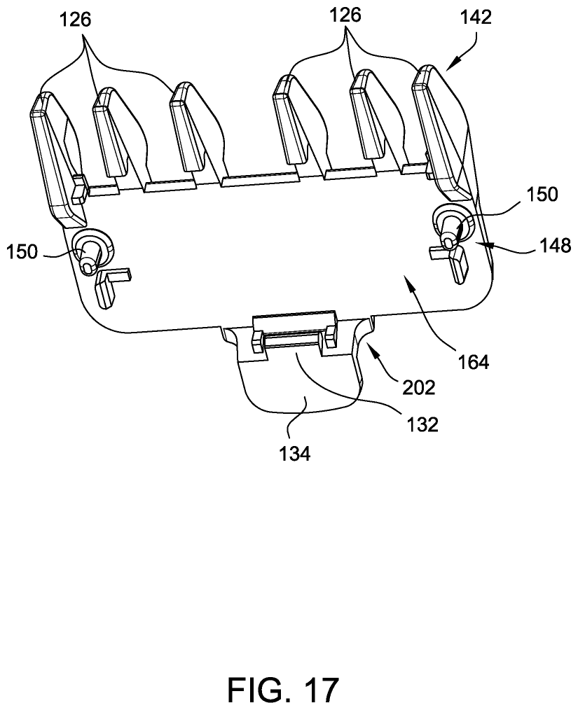

FIGS. 16 and 17 show a third stackable comb 142 of the set 122 (shown in FIG. 3). The third stackable comb 142 is similar to the second stackable comb 140 except the third stackable comb 142 is a different size than the second stackable comb 140. In the illustrated embodiment, the third stackable comb 142 is configured to provide a cut length of approximately 6 mm when used with the trimmer 100 (shown in FIG. 1).

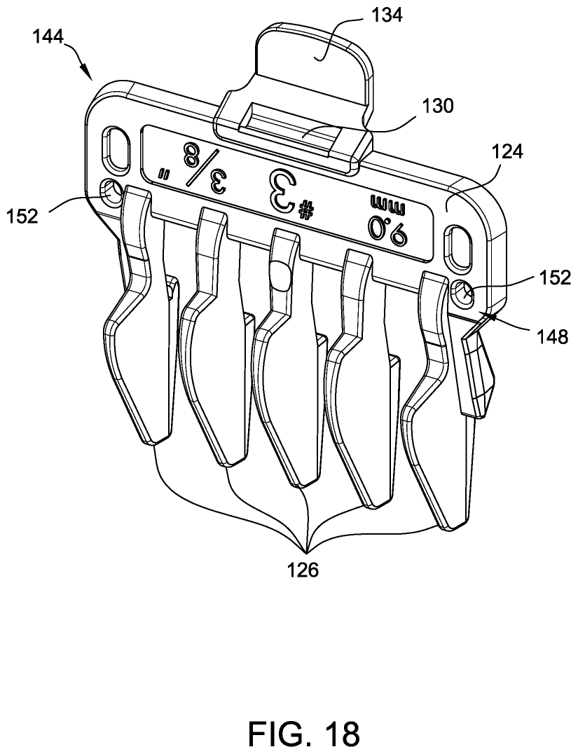

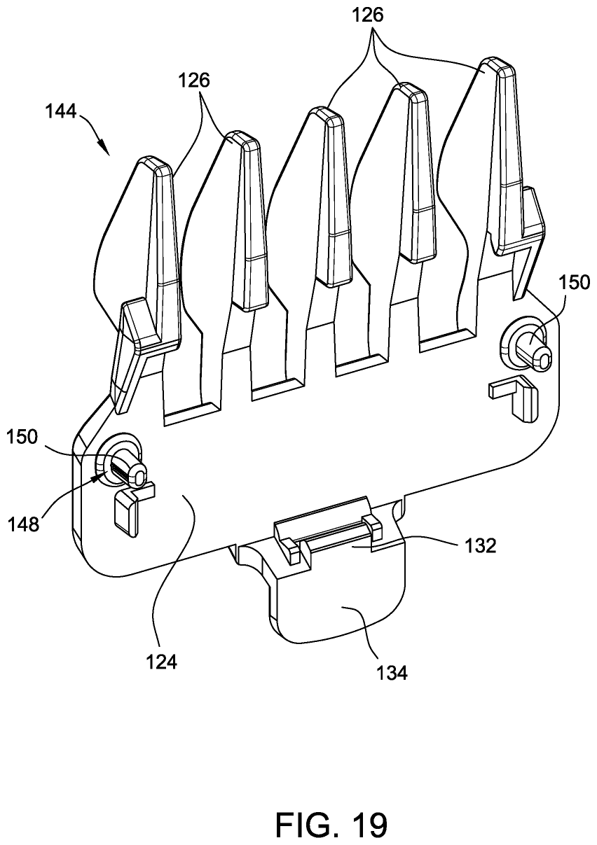

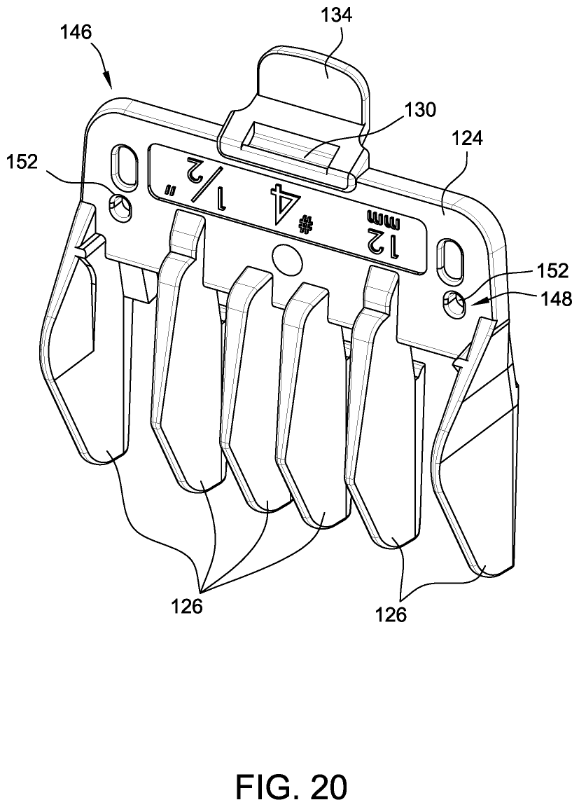

FIGS. 18 and 19 show a fourth stackable comb 144 of the set 122 (shown in FIG. 3). The fourth stackable comb 144 is similar to the second and third stackable combs 140, 142 except the fourth stackable comb 144 is a different size than the second and third stackable combs 140, 142. In the illustrated embodiment, the fourth stackable comb 144 is configured to provide a cut length of approximately 9 mm when used with the trimmer 100 (shown in FIG. 1).

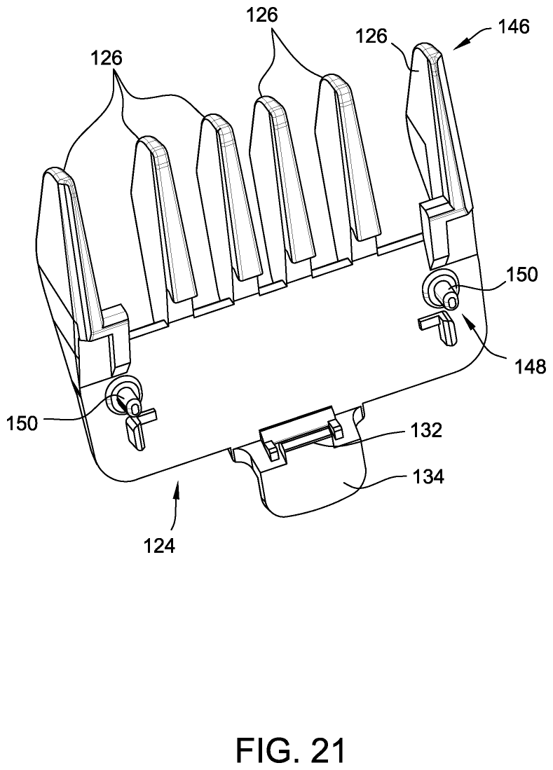

FIGS. 20 and 21 show a fifth stackable comb 146 of the set 122 (shown in FIG. 3). The fifth stackable comb 146 is similar to the second, third, and fourth stackable combs 140, 142, 144 except the fifth stackable comb 146 is a different size than the second, third, and fourth stackable combs 140, 142, 144. In the illustrated embodiment, the fifth stackable comb 146 is configured to provide a cut length of approximately 12 mm when used with the trimmer 100 (shown in FIG. 1).

The fifth stackable comb 146 is the largest comb 120 of the illustrated set 122 (shown in FIG. 3). In some suitable embodiments, the set 122 includes combs 120 that are larger than the fifth stackable comb 146.

As shown in FIGS. 3-5, the combs 120 are releasably attachable together in a stacked configuration. For example, a user positions the first stackable comb 138 onto the second stackable comb 140 such that the posts 150 on the first stackable comb 138 are aligned with the openings 152 in the second stackable comb 140. The user presses the first stackable comb 138 and the second stackable comb 140 together and the latch 132 on the first stackable comb 138 engages the slot 130 on the second stackable comb 140 to secure the stackable combs 120 together. The user positions the third stackable comb 142 onto the stack of the first stackable comb 138 and the second stackable comb 140 such that the posts 150 on the second stackable comb 140 are aligned with the openings 152 in the third stackable comb 142. The user presses the third stackable comb 142 against the second stackable comb 140 and the latch 132 of the second stackable comb 140 engages the slot 130 of the third stackable comb 142 to secure the stackable combs 140, 142 together. The user positions the fourth stackable comb 144 onto the stack of the first stackable comb 138, the second stackable comb 140, and the third stackable comb 142 such that the posts 150 on the third stackable comb 142 are aligned with the openings 152 in the fourth stackable comb 144. The user presses the fourth stackable comb 144 against the third stackable comb 142 and the latch 132 of the third stackable comb 142 engages the slot 130 of the fourth stackable comb 144 to secure the stackable combs 142, 144 together. The user positions the fifth stackable comb 146 onto the stack of the first stackable comb 138, the second stackable comb 140, the third stackable comb 142, and the fourth stackable comb 144 such that the posts 150 on the fourth stackable comb 144 are aligned with the openings 152 in the fifth stackable comb 146. The user presses the fifth stackable comb 146 against and the fourth stackable comb 144 and the latch 132 of the fourth stackable comb 144 engages the slot 130 of the fifth stackable comb 146 to secure the stackable combs 144, 146 together.

In the exemplary embodiment, the stackable combs 120 are attached together in order of cutting height. Accordingly, the stacked arrangement of the combs 120 is compact and the combs 120 in the stack are organized by size. However, the stackable combs 120 may be attached together in any suitable order because the engagement features on the stackable attachment comb 120 are identical. For example, a user may attach a stackable comb (s) 120 that is commonly used to an end of the stacked arrangement to allow for easy access to the comb 120.

Referring to FIGS. 1-7, in operation a user selects a desired cut length provided by one of the stackable combs 120 and removes the selected comb 120 from the stack. For example, the user presses on the tab 134 of the selected comb 120 or an attached comb 120 to remove the latch 132 from the slot 130 and release the selected comb 120. Also, the user detaches the selected comb 120 from another attached comb 120 if the selected comb 120 is attached to combs 120 on both sides. If a previous comb 120 was attached to the trimmer 100, the user removes the comb 120 from the trimmer 100. The user may attach the removed comb 120 to the other comb (s) 120 in the stacked arrangement. The user positions the selected comb 120 onto the blade assembly 106 of the trimmer 100 and the latch 132 engages the blade assembly 106 and/or another part of the trimmer 100 to secure the comb 120 onto the blade assembly 106. The user operates the trimmer 100 to cut hair to the desired length using the comb 120. After cutting hair, the user removes the comb 120 from the trimmer 100 and reattaches the comb 120 to the stack of combs 120.

In an embodiment, a comb kit includes a plurality of the combs 120. For example, the kit includes at least two different sized combs 120 configured to provide two different hair cut lengths. Specifically, in an embodiment, the comb kit includes at least (i) a 1.5 mm comb, (ii) a 3 mm comb, (iii) a 6 mm comb, (iv) a 9 mm comb, and (v) a 12 mm comb. The combs 120 are configured to attach together in a stacked arrangement. The combs 120 of the comb kit require less space to store in the stacked arrangement than conventional combs and facilitate a user quickly locating a desired comb 120 of the set.

In an embodiment, a trimmer kit includes a trimmer 100 and at least two attachments. Specifically, in an embodiment, the trimmer kit includes the trimmer 100 and at least two different stackable attachment combs 120. The trimmer kit allows the user to cut the person's hair 114 to two different hair lengths. In some embodiments, the trimmer kit includes the trimmer 100 and the comb kit.

Embodiments of comb attachments for electric hair trimmers and kits including comb attachments described herein provide comb attachments that are releasably connectable together. The comb attachments are compact and easy to store in the connected arrangement. The comb attachments are organizable by size, type, user preference, and/or any other characteristic. The comb attachments have a snap fit connection to allow for quick detachment from or reattachment to each other or the electric hair trimmer. Moreover, the comb attachments are modular, and the comb attachments have the same engagement features to attach to each other. In addition, the comb attachments utilize the same engagement features to attach to the electric hair trimmer and to other combs. Moreover, the comb attachments are simpler to manufacture and more durable than comb attachments that include multiple pieces attached together because the comb attachments are each a single piece.

When introducing elements of the present invention or the preferred embodiment (s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions without departing from the scope of the disclosure, it is intended that all matter contained in the above description or shown in the accompanying drawings shall be interpreted as illustrative and not in a limiting sense.

What is claimed is:

1. A stackable attachment comb for use with an electric hair trimmer, the stackable attachment comb comprising:
a body configured to releasably attach to the electric hair trimmer and;
teeth projecting from the body, wherein the teeth are arranged to direct hair toward a blade assembly of the electric hair trimmer for cutting during operation of the electric hair trimmer if the body is attached to the electric hair trimmer; and
an engagement feature integrally formed with the body and configured to attach the stackable attachment comb to another comb.

2. The stackable attachment comb of claim 1 further comprising at least one tab extending from the body for releasing the stackable attachment comb from the electric hair trimmer.

3. The stackable attachment comb of claim 2, wherein the engagement feature comprises a latch, and wherein the tab is attached to the body proximate the latch and extends outward from the latch.

4. The stackable attachment comb of claim 3 further comprising a slot in the body, wherein the latch is sized to extend into the slot of another comb to attach the combs together.

5. The stackable attachment comb of claim 1, wherein the body includes an outer surface, an inner surface, and an edge extending around the inner and outer surfaces, the engagement feature configured to attach the stackable attachment comb to another comb such that the outer surface faces the inner surface of the other comb.

6. The stackable attachment comb of claim 5, wherein the engagement feature comprises a slot in the body, and wherein the slot extends along at least a portion of the edge.

7. The stackable attachment comb of claim 1 further comprising at least one alignment feature that is configured to align the stackable attachment comb with another comb when the combs are attached together.

8. The stackable attachment comb of claim 7, wherein the at least one alignment feature comprises a post that is configured to extend into an opening of the other comb.

9. The stackable attachment comb of claim 7, wherein the at least one alignment feature comprises an opening that is positioned to receive a post of the other comb.

10. A set of stackable attachment combs for use with a hair trimmer, the set comprising:
a first comb including teeth; and
a second comb including teeth, wherein the first comb includes an engagement feature configured to attach the first comb to the second comb and to the hair trimmer.

11. The set of claim 10 further comprising a third comb including teeth, wherein the third comb includes an engagement feature configured to attach the third comb to the second comb or the first comb.

12. The set of claim 11, wherein the first comb, the second comb, and the third comb are configured to attach together in order of size.

13. The set of claim 11, wherein the first comb, the second comb, and the third comb are configured to attach together in a stacked arrangement such that the second comb is between the first comb and the third comb.

14. The set of claim 10, wherein at least one of the first comb and the second comb has an alignment feature that aligns the first comb and the second comb such that the teeth of the first and second combs are parallel when the combs are attached together.

15. An electric hair trimmer kit comprising:
an electric hair trimmer having a blade assembly, wherein the blade assembly is operable to cut hair during operation of the electric hair trimmer; and
a plurality of combs configured to releasably attach to the electric hair trimmer and direct hair toward the blade assembly for cutting during operation of the electric hair trimmer, wherein each comb includes teeth, and wherein at least one of the combs includes an engagement feature configured to attach the combs together in a stacked arrangement if the combs are detached from the electric hair trimmer.

16. The kit of claim 15, wherein the plurality of combs is configured to attach together in order of size.

17. The kit of claim 15, wherein each comb includes a body including a slot and a latch that is sized to engage a slot in the body of another comb.

18. The kit of claim 17, wherein each comb includes at least one tab extending from the body, the tab configured to release the comb from the electric hair trimmer and from another comb.

19. The kit of claim 15, wherein each comb includes a body having an outer surface, an inner surface, and an edge extending around the inner and outer surfaces, wherein the engagement feature is configured to attach the comb to another comb such that the outer surface faces the inner surface of the other comb.

20. The kit of claim 19, wherein the engagement feature comprises a slot in the body, the slot extending along at least a portion of the edge.

21. A set of stackable attachment combs for use with a hair trimmer, each stackable attachment comb of the set including teeth, wherein at least one stackable attachment comb of the set includes an engagement feature configured to attach the stackable attachment comb to another stackable attachment comb of the set and to the hair trimmer.

22. The set of claim 11, wherein each stackable attachment comb of the set includes the engagement feature, and wherein the stackable attachment combs of the set are configured to attach together in any order.
